(19) United States
(12) Patent Application Publication
(10) Pub. No.: US 2026/0204112 A1
(43) Pub. Date: Jul. 16, 2026

(54) ELECTRIC MULTI-CONTACT SYSTEM WITH KEY HAVING INSULATING ZONES

(71) Applicant: NEXIALISTE NORMAND, LA BREDE (FR)

(72) Inventor: Franck PROUX, Bouliac (FR)

(73) Assignee: NEXIALISTE NORMAND, LA BREDE (FR)

(21) Appl. No.: 19/136,391

(22) PCT Filed: Nov. 21, 2023
(86) PCT No.: PCT/EP2023/082618

§ 371 Date: Jun. 6, 2025

(30) Foreign Application Priority Data
Dec. 12, 2022 (FR) FR2213193

(51) Int. Cl. G07C 9/00

(52) U.S. Cl. CPC G07C 9/00309; G07C 9/00706; G07C 9/00944; G07C 2009/00412

(57) ABSTRACT

The invention relates to a multi-contact system (100) comprising a housing (2) defining a cavity (16) configured to accommodate an encrypted portion (1A) of a key (1), the encrypted portion (1A) of the key (1) having an encryption section (1B) made of conductive material, the housing (2) comprising electrical contacts (17) for making contact with the encryption section (1B) when the key (1) is in the inserted position, the electrical contacts (17) being connected to a computing unit (15) that is configured to communicate with an effector (40), the encryption section (1B) of the encrypted portion (1A) of the key (1) comprising insulating zones (22), the multi-contact system (100) forming, in the inserted position of the key: an open switch for each of the electrical contacts opposite one of the insulating zones (22); and a closed switch for each of the electrical contacts (17) which is in contact with the encryption section (1B) outside these insulating zones.

### TECHNICAL FIELD OF THE INVENTION

The invention relates, in general, to the technical field of keys and locks.

The invention relates more specifically to a multi-contact system comprising a housing delimiting a cavity configured to receive at least an encrypted portion of a key, the encrypted portion of the key having an encryption section formed at least in part by an electrically conductive material, the housing comprising a plurality of electrical contacts on an inner surface of the cavity intended to make contact with the encryption section of the encrypted portion of the key when said key is in the inserted position in the cavity of the housing, said electrical contacts being connected to a microcontroller configured to communicate with an effector.

### STATE OF THE ART

There are mechanical locks ranging from latches to pin locks, electrified locks that activate a servomotor or electromagnetic system, locks controlled by image recognition (fingerprints, retina, iris, face, etc.), radio-controlled locks, etc.

Pin locks are among the most widely used, and their industrialization has been perfectly mastered. They rely on the use of superimposed pins in bores so that, when the key pushes against the upper pin, the interface between the pins coincides with a shear plane allowing a rotor to rotate within a stator or a moving part to slide relative to a fixed part. This proven technology is highly reliable, but requires high machining quality with close tolerances.

All have their advantages and disadvantages, and the ideal lock must meet a number of requirements that can be difficult to reconcile.

Thus, the key must be practical, inexpensive, easy to produce but difficult to reproduce, robust but not bulky, etc. The lock must be resistant to picks, bumping, drilling and brute force attacks, while being as inexpensive as possible; it must not be too heavy or cumbersome, so that it can be attached to doors without damaging them too much, easy to manufacture with as little machining as possible, maintain good lubrication over time, resist hacking for digitally or computer-controlled locks, and so on.

No lock is currently tamper-proof. As always with theft protection, the universal concept is that, to be effective, the locking system must require more energy or more money to force than the things to be protected, or at any rate take so long that the intruder is likely to be interrupted before he has completed his task.

In most vehicles, turning the ignition key in the lock turns on the ignition by connecting two wires, thus closing the electrical circuit that powers the vehicle. Turning it further, or pressing a switch, closes the starter circuit and starts the engine. This conventional system is very practical and widely used, but removing the lock or accessing the two ignition wires and the starter wire to start the vehicle. Furthermore, these pin-and-barrel locks are quite expensive, requiring high-precision machining and the use of high-quality metal alloys.

Electronic key systems contain an infrared or radio remote control and a transponder. When the driver switches on the ignition, the transponder activates the electric current and the vehicle starts. The transponder is generally made up of two parts located in the vehicle's key and contactor. The transponder can also be connected to the solenoid valve on the fuel pump to prevent ignition, providing a highly effective immobilizer. Complex, time-consuming disassembly is the only way to use the vehicle. These systems can be hacked, however, sometimes very quickly with the right electronic or computer tools, and the race between the thief and the protection is often won by the criminal. Furthermore, the cost of this type of device is fairly high, limiting its use to luxury vehicles.

Numerous patents have been filed for multi-contact devices (U.S. Pat. No. 9,748,685B2, EP2485334B1, US20120202391A1, etc.), but these systems are not designed to be connected and disconnected tens of thousands of times, and therefore cannot be used as key and lock systems. Indeed, the cards are made of insulating material, with electrical contact zones on the surface. These zones are quite thin and susceptible to delamination, wear or disconnection from the conductors connecting them.

Patent FR2108751 under examination uses spring-mounted pins in wells to make contact between a metal key and conductors connected to a transponder. The system consists of a housing comprising a cover and a housing body wherein the pin shafts are bored. Each well comprises a pin, a spring and a plug or shoulder in the well to replace the plug and hold the spring. The housing is bored under the cover to allow the key to be inserted. Bores in the key ensure that the pins do not touch their contact when the pins are up against a bore, thus forming an open switch. When the pins are in the lower position in contact with the key without bore, they touch their contact and form a closed switch. This pin-based system is extremely reliable and robust, but requires a certain thickness and several manufacturing operations.

### DISCLOSURE OF THE INVENTION

The aim of the invention is to remedy some or all of the disadvantages of the current state of the art, in particular by proposing a key solution that offers an improved guarantee of security by increasing the level of tamper resistance, while being both reliable in operation and durable over time

Another objective is to simplify key operation, while reducing the thickness and number of parts, as well as manufacturing costs.

To this end, according to a first aspect of the invention, proposed is a multi-contact system comprising a housing delimiting a cavity configured to receive at least an encrypted portion of a key, the encrypted portion of the key having an encryption section formed at least in part by an electrically conductive material, the housing comprising a plurality of electrical contacts on an inner surface of the cavity intended to make contact with the encryption section of the encrypted portion of the key when said key is in the inserted position in the cavity of the housing, said electrical contacts being connected to a computing unit configured to communicate with an effector, the multi-contact system being characterized in that the encryption section of the encrypted portion of the key comprises electrically insulating zones, the multi-contact system being configured to form, when the key is in the inserted position in the cavity of the housing:
an open switch for each of the electrical contacts located opposite an insulating contact zone of the encryption section of the encrypted portion of the key formed by one of the insulating zones; and
a closed switch for each of the electrical contacts which is in contact with a conductive contact zone of the encryption section of the encrypted portion of the key outside these insulating zones, the conductive contact zone being electrically conductive.

According to one embodiment, the housing comprises a housing body and a cover, the cavity of the housing being delimited at least in part by the body of the housing and the cover, the electrical contacts preferably being secured to the cover. The configuration wherein the electrical contacts are preferably secured to the cover facilitates any repair and/or maintenance operations, improving the repairability index of the multi-contact system.

According to one embodiment, the multi-contact system comprises a printed circuit board secured to the housing, the printed circuit board preferably being secured to the cover, the printed circuit board preferably also constituting the cover.

According to one embodiment, the contact zones of the encryption section of the encrypted portion of the key, each intended to be in contact with one of the electrical contacts in a position in which the key is inserted into the cavity of the housing, are visually identical. In particular, this makes the key more difficult to copy by making all combinations visually identical, as the insulating and conducting contact zones are visually indistinguishable.

According to one embodiment, some or all of the contact zones, preferably all of the contact zones, comprise a metal core surrounded by a ring of electrically insulating material(s). Whether insulating or conducting, these insulating rings are arranged so as to be parallel to a surface plane of a useful face of the key, that is, the face of the encryption section of the encrypted portion of the key, and preferably still flush with this surface so as to be visible. Whatever the contact zone, insulating or conducting, the same ring will be visible, making it impossible to distinguish them from the outside.

According to one embodiment, in the conductive contact zones, each of the metal cores is electrically connected to the electrically conductive material of the encryption section of the encrypted portion of the key.

According to one embodiment, in the insulating contact zones, each of the metal cores is electrically insulated from the electrically conductive material of the encryption section of the encrypted portion of the key by means of an insulating envelope consisting at least of the ring and a complementary element such as a sleeve or partition made of electrically insulating material(s).

According to one embodiment, the key has recesses forming wells located at each contact zone for receiving studs, each well of a conductive contact zone which is configured to receive a conductive stud and each well of an insulating contact zone being configured to receive an insulating stud. Owing to such a configuration, the key is particularly simplified, making it possible firstly to manufacture a key body fitted with wells, and then to fit conductive and insulating studs according to the key code to accommodate them in the associated wells, according to the key code. The manufacture of the key body no longer depends on the key code.

According to one embodiment, each of the recesses or wells comprises a partition insert configured to cover a bottom of the associated well. Preferably, this partition is made of electrically insulating material(s) for all wells, and even more preferably the partition is identical for all wells. This simplifies the key manufacturing method, as the installation of this partition does not depend on the key code.

According to one embodiment, each of the studs comprises a metal core surrounded on an upper portion of the core by a ring of electrically insulating material(s). Preferably in this case, each pair of a metal core and a ring of electrically insulating material(s) is identical for all contact zones, that is, for all wells.

According to one embodiment, each conductive stud is surrounded, at least in part on a lower portion, by an electrically conductive element, preferably located vertically below the insulating ring, so as to conduct electricity between the metal core and the side wall of the associated well in the inserted position of the corresponding conductive stud. In the inserted position of an associated conductive stud, the electrically conductive element is placed, preferably interposed, vertically between the partition (whether made of electrically insulating or conductive material(s)) below and the insulating ring above, the latter being visible to the user.

According to one embodiment, the electrically insulating zones are formed at least in part, preferably by an insulating coating deposited locally on the surface of the encryption section of the encrypted portion of the key. In the event that it is desired that the contact zones of the encryption section of the encrypted portion of the key, each intended to be in contact with one of the electrical contacts in a position in which the key is inserted into the cavity of the housing, be visually identical, the electrically conductive zones comprise a conductive coating deposited locally on the surface of the encryption section of the encrypted portion of the key, the conductive coating then being chosen to be visually identical to the insulating coating.

According to one embodiment, the key has recesses located at each insulating zone and filled with an electrically insulating material, this material having an outer surface flush with an outer surface of the encryption section of the encrypted portion of the key in order to limit wear on the electrical contacts against which the key rubs when it is inserted into its cavity.

According to one embodiment, the multi-contact system comprises at least one resiliently retractable lug configured to penetrate the cavity and insert into a notch in the encrypted portion of the key when said key is in the inserted position in the cavity of the housing so as to maintain the key in its inserted position and inform the user of a correct inserted position of said key.

According to one embodiment, the cavity of the housing has a complementary shape to that of the encrypted portion of the key, so that said encrypted portion of the key can slide in the cavity while being guided and constrained in its translation and positioning.

According to one embodiment, the body of the housing is made of metallic material(s) and connected to an electrical terminal of an electrical dipole.

According to one embodiment, the body of the housing is made of electrically insulating material(s), for example plastic material(s), the body of the housing comprising a plug for connecting an electrical terminal of an electrical dipole to the key when said key is in its inserted position in the housing.

According to one embodiment, the electrical contacts comprise resilient means configured to resiliently constrain said electrical contacts in contact and in abutment against the encryption section of the encrypted portion of the key, in the inserted position of the key in the cavity of the housing.

According to one embodiment, the encrypted portion of the key intended to cooperate in the cavity of the housing has side faces each chamfered so as to have a trapezoidal cross-section, a distal end of the encrypted portion of the key preferably also having a chamfered front face. The advantage of this shape is that it acts as a keying feature, protects the electrical contacts and the printed circuit board (PCB) from excessive pressure of the key on the latter, and is more economical to manufacture.

According to one embodiment, the electrical contacts each comprise an assembly of two sliding cylinders constrained against one another by an internal spring; the electrical contacts each preferably comprise a Pogo™ pin. The use of such pins simplifies the overall structure of the multi-contact system and reduces the number of components.

According to one embodiment, the computing unit is configured to communicate with the effector by sending it information such as a predetermined encryption key, for example a key comprising a few hundred or even thousands of bits, if a predetermined combination of electrical contacts are connected to a predetermined electrical pole. As another example, the predetermined encryption key can be a 128-bit or 256-bit key.

According to one embodiment, the computing unit is configured to detect electrical contacts in an electrified state, and preferably, when an erroneous combination, different from the predetermined combination of electrical contacts, is detected, the computing unit triggers a refractory period preventing any further testing of the key for a predefined time.

The invention also relates to an actuating mechanism for an apparatus, comprising a multi-contact system as described above, the actuating mechanism being configured to command the effector to actuate the apparatus when the key is inserted into the cavity of the housing and the key is recognized by the multi-contact system, in particular when a predetermined combination of electrical contacts are connected to a predetermined electrical pole, the predetermined combination being representative of the insertion of the key of the apparatus into the cavity of the housing.

The term “actuation” is used here in the broadest sense, and can refer to any action such as a command to start, stop or authorize access, for example by electrifying a magnetic lock, or to authorize access to a computer terminal, a computer file or a computer network, or to authorize or deny the use of a function of the apparatus.

According to one embodiment, the actuating mechanism is an ignition switch for an apparatus such as a motorized road vehicle, with actuation of the apparatus corresponding to starting of the vehicle.

The invention also relates to an ignition switch for a motorized road vehicle. The ignition switch features the multi-contact system. The ignition switch is configured to command the effector to start the vehicle when the vehicle key is inserted in the cavity of the housing and the key is recognized by the multi-contact system. In particular, the key is recognized by the multi-contact system when a predetermined combination of electrical contacts are connected to a predetermined electrical pole, the predetermined combination of electrical contacts being representative of the insertion of the vehicle key into the housing.

The object of the invention also relates to an actuation control member comprising an effector and a multi-contact system as described above, the actuation control member comprising a control unit including a microprocessor and/or a microcontroller, the control unit being configured to allow actuation of the apparatus when the key is inserted in the cavity of the housing and the key is recognized by the multi-contact system, the control unit being connected to a main module of the effector by a switch which is configured to switch between an actuation position wherein the effector allows actuation of the apparatus and a stop position wherein the effector prevents actuation of the apparatus.

According to one embodiment, the actuation control member is an ignition member for an apparatus such as a motorized road vehicle, with actuation of the apparatus corresponding to starting of the vehicle.

The invention thus also relates to an ignition control member comprising an effector and the multi-contact system. The ignition control member comprises a control unit with a microprocessor and/or microcontroller. The control unit is configured to enable the vehicle to be started when the key is inserted into the cavity of the housing and the key is recognized by the multi-contact system. The control unit is connected to a main module of the effector by a switch which is configured to switch between an ignition position wherein the effector allows the vehicle to be started and a stop position wherein the effector prevents the vehicle from being started.

Such a multi-contact system therefore offers a simple mechanical man-machine interface (a key to be inserted into a housing) that enables a cipher, such as a very complicated password contained in a microcontroller activated by the right key, to be sent to the electronic circuit of a vehicle's main component or any system to be protected. The whole package is very affordable. The mechanical combination and password can be randomly assigned in the production process. Such a system can easily be added to or replace existing systems.

### BRIEF DESCRIPTION OF THE FIGURES

Other features and advantages of the invention will become apparent on reading the following description, with reference to the appended figures, which show:

FIG. 1: a schematic and isometric perspective representation of a multi-contact locking system according to one embodiment, with the key in the inserted position in a housing;

FIG. 2: a schematic front view of the multi-contact locking system shown in FIG. 1, with the key in the inserted position in the housing;

FIG. 3: a schematic view of the bottom of the multi-contact locking system shown in FIG. 1;

FIG. 4: a schematic isometric perspective view from below of the key as shown in the embodiment of FIG. 2, in a position disengaged from the housing;

FIG. 5: a horizontal cross-section of FIG. 1, with the key in the inserted position in a housing;

FIG. 6: a schematic diagram of the operating principle of an electrical contact, according to one embodiment;

FIG. 7: a vertical cross-section of the housing passing through several electrical contacts, in a key-free position, that is, without the key inserted in the associated cavity of the housing;

FIG. 8: a figure similar to FIG. 7, with the key in the inserted position in the housing;

FIG. 9: a schematic representation of the operating principle of the multi-contact system as shown in the embodiment of FIG. 1, showing an ignition control member according to a first embodiment;

FIG. 10: a bottom view of a key according to another embodiment;

FIG. 11: a longitudinal vertical cross-sectional view of the key of FIG. 10;

FIG. 12: an isometric perspective view of a longitudinal vertical cross-section of the multi-contact system according to another embodiment similar to FIG. 11, with the key in the inserted position in a housing;

FIG. 13: an isometric perspective view of a key body according to another embodiment, in a position disengaged from the housing;

FIG. 14: an isometric perspective view of a vertical cross-section of a key according to the embodiment of FIG. 13;

FIG. 15: an isometric perspective view of a vertical cross-section of a key according to the embodiment of FIG. 13, in a detail view of an encryption section of an encrypted portion of the key;

FIG. 16: an isometric perspective view of an insulating stud according to the embodiment of FIG. 15;

FIG. 17: an isometric perspective view of a conductive stud according to the embodiment of FIG. 15;

FIG. 18: an isometric perspective view of a conductive stud according to a variant embodiment of FIG. 17;

FIG. 19: a schematic view of an operating principle of an ignition control member according to a second embodiment;

FIG. 20: an operating diagram of the multi-contact system of the ignition control member according to the second embodiment;

FIG. 21: an operating diagram of an ignition control control unit according to the second embodiment.

For greater clarity, identical or similar elements are identified by identical reference signs in all of the Figures.

### DETAILED DESCRIPTION OF ONE EMBODIMENT

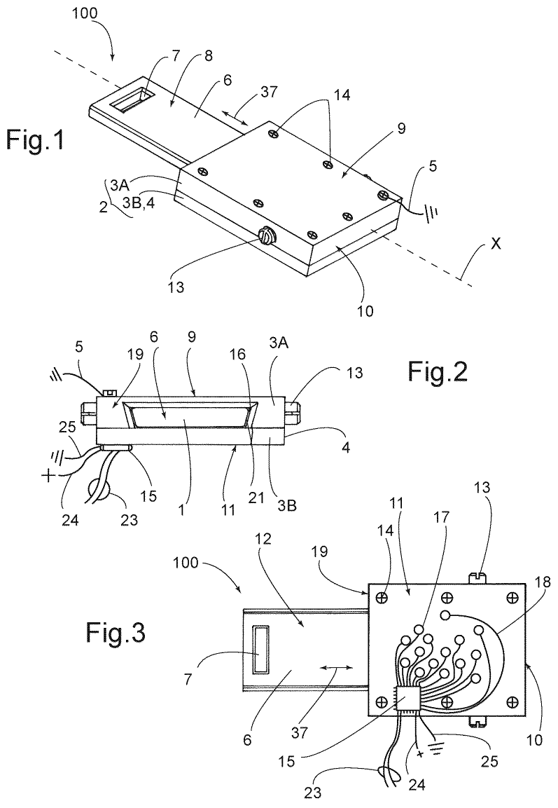

FIG. 1 shows a schematic and isometric perspective depiction of a multi-contact locking system 100 according to one embodiment. This multi-contact system 100 is made up of a housing 2 into which a key 1 can be inserted. In the embodiment shown, the multi-contact system 100 is for an ignition switch of a motorized road vehicle such as a car. An ignition switch is also known in the state of the art as a “Neiman”. The ignition switch is configured to prevent the vehicle from starting when the key 1 is not recognized by the multi-contact system 100, and to enable the vehicle to start when the key 1 is recognized. However, the multi-contact system 100 according to the invention is not only limited to use in an ignition switch.

The key 1 has a handle 6 which forms a head of the key 1 and is configured to provide a gripping zone for the key 1 for a user. The key 1 also includes an encrypted portion 1A located in an axial extension of the handle along a reference axis X, the encrypted portion 1A being designed to be received in a cavity 16 of the housing 2. In the inserted position of the key 1 in the housing 2, only the handle 6 of the key 1 protrudes from the housing, that is, the handle 6 remains protruding from said housing 2 in this inserted position. The handle 6 of the key 1 is provided with a key-holder hole 7 for convenient and efficient attachment to a keyring.

The housing 2 comprises a housing 2 body 3A a cover 3B, which are secured together by fastening means. The cover 3B is attached to the body 3A by screws 14, for example, and without limitations. The housing 2 delimits an interior space of the cavity 16 and has an axial opening for insertion of the key 1 from a front face 19 of the housing 2 and through which the key 1 is inserted axially into said cavity 16. The direction of translation of key 1 is shown by arrow 37 (see FIG. 1). The front face 19 of the housing 2 is axially opposite a rear face 10 of the housing 2, said housing 2 being vertically delimited by two lower 11 and upper 9 faces.

The housing 2 is formed here by assembling the body 3A of the housing 2 with the cover 3B, these two parts together delimiting the cavity 16. Of course, in a particular, but non-limiting, embodiment, the housing 2 can be formed in a single piece.

FIG. 2 shows a schematic front view of the multi-contact locking system shown in FIG. 1, with the key 1 inserted in the housing 2.

The cavity 16 takes the form of a slot into which the encrypted portion 1A can be inserted. The cavity 16 of the housing 2 has a complementary shape to that of the encrypted portion 1A of the key 1, so that said encrypted portion of the key 1 can slide axially in the cavity 16 while being guided and constrained in its translation and positioning by said cavity 16.

The encrypted portion 1A of the key 1 extends generally axially from the head of the key 1 formed by the handle 6 of the key 1 to a distal end. The encrypted portion 1A of the key 1 comprises an encryption section 1B formed at least in part by an electrically conductive material. The encryption section 1B can be either a part attached to the encrypted portion 1A of the key 1, for example in the form of a metal sheet attached to the encrypted section 1A of the key 1, formed from a plastic material for example. In another advantageous configuration, the encryption section 1B can be formed integrally with the encrypted portion 1A of the key 1, for example in the form of a piece of electrically conductive material, such as a metal-based material.

The housing 2 comprises a plurality of electrical contacts 17 (visible in detail in FIG. 8, for example), each of these electrical contacts 17 being arranged at least on an inner surface 36 of the cavity 16 and intended to make contact with the encryption section 1B of the encrypted portion 1A of the key 1 when said key 1 is in the inserted position in the cavity 16 of the housing 2.

In accordance with the invention, the encryption section 1B of the encrypted portion 1A of the key 1 comprises electrically insulating zones 22, the multi-contact system 100 being configured to form, when the key 1 is in the inserted position in the cavity 16 of the housing 2:
an open switch for each of the electrical contacts 17 located opposite an insulating contact zone of the encryption section 1B of the encrypted portion 1A of the key 1 formed by one of the insulating zones 22; and
a closed switch for each of the electrical contacts 17 which is in contact with a conductive contact zone 41 of the encryption section 1B of the encrypted portion 1A of the key 1 outside these insulating zones, the contact zone 41 being electrically conductive.

As can be seen in FIGS. 1 and 2, the housing 2 is formed by assembling the body 3A of the housing 2 with the cover 3B, which together delimit the cavity 16. The body 3A of the housing 2 is machined to define the cavity 16 transversely, laterally and axially with respect to the reference axis X. The cavity 16 is vertically delimited on one side by a first face 35 carried by the body 3A of the housing 2 and on the other side by a second face 36 carried by the cover 3B constituted here by the integrated circuit 4.

According to one embodiment, the body 3A of the housing 2 is made from metallic material(s) and connected to an electrical terminal of an electrical dipole.

According to another embodiment, the body 3A of the housing 2 is made of electrically insulating materials, for example plastic material(s), the body 3A of the housing 2 comprising a plug for connecting an electrical terminal of an electrical dipole to the key 1 when said key 1 is in its inserted position in the housing 2.

In this embodiment, the cover 3B of the housing 2 is a flat element, substantially parallel to a horizontal plane containing the reference axis X, and forming a support for the electrical contacts 17. In other words, the electrical contacts 17 are each secured to the cover 3B. The multi-contact system 100 comprises a printed circuit board 4 secured to the housing 2, with the cover 3B forming the printed circuit board 4.

Thus, the printed circuit board 4 comprises electrical contacts on one 36 of its faces facing the cavity 16 of the housing 2 and designed to make contact with a useful face 12 of the key 1, in particular the face 12 of the encrypted portion 1A of the key 1 carried by the encryption section 1B when said key 1 is in the position inserted in the cavity 16 of the housing 2.

The encryption section 1B of the encrypted portion 1A of the key 1 is made of metal. The electrically insulating zones 22 are formed, preferably by an insulating coating deposited locally on the surface of the encryption section 1B of the encrypted portion 1A of the key 1. In this embodiment, the encryption section 1B is formed integrally with the encrypted portion 1A of the key 1 in the form of a piece of electrically conductive material, such as a metal-based material. The result is a fully conductive key 1, or one with a conductive body and insulating zones.

More precisely, the key 1 has recesses located at each predetermined insulating zone 22 associated with the key 1 and filled with an electrically insulating material, this material having an outer surface flush with an outer surface 12 of the encryption section 1B of the encrypted portion 1A of the key 1 in order to limit wear on the electrical contacts 17 against which the key 1 rubs when it is inserted into its cavity 16. Insulating material can be introduced into each of the recesses located at an associated insulating zone 22 by any method preferred by the person skilled in the art, e.g. casting, force-fitting, gluing, etc.

FIG. 3 shows a schematic view of the bottom of the multi-contact locking system 100 shown in FIG. 2.

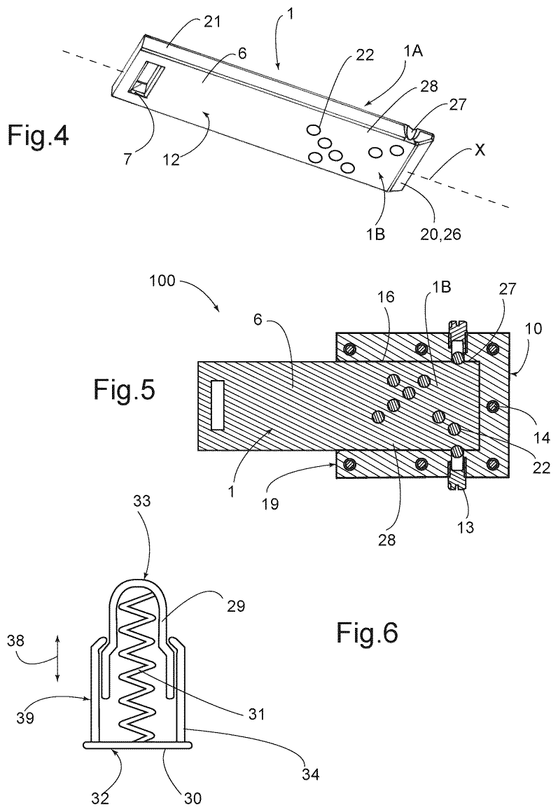

FIG. 4 shows a schematic isometric perspective view from below of the key 1 according to the embodiment of FIG. 2, in a position disengaged from the housing 2.

As can be seen in detail in FIGS. 3 and 4, the key 1 is provided with at least one notch 27 in its encrypted portion 1A, into which a resiliently retractable lug 13 of the housing 2 can penetrate to hold the key 1 in its inserted position and to inform the user of the correct inserted position of said key 1.

In particular, the encrypted portion 1A of the key 1 intended to cooperate in the cavity 16 of the housing 2 has:
side faces 21 together transversely delimiting a width of the encrypted portion 1A of the key 1, each of the side faces being designed to face one of the lateral sides of the cavity 16 of the housing 2, when said key 1 is in the inserted position in the cavity 16 of the housing 2; and
a front face 20 delimiting the distal end of the key 1 designed to face a side axially delimiting a bottom of the cavity 16 of the housing 2, when said key 1 is in the inserted position in the cavity 16 of the housing 2.

The multi-contact system 100 comprises at least one, preferably two, resiliently retractable lugs 13 secured to a first of the key 1 and the housing 2, and at least one, preferably two, notches 27 secured to a second of the housing 2 and the key 1, each resiliently retractable lug 13 being configured for insertion into an associated notch 27. For ease of manufacture, the resiliently retractable lugs 13 are secured to the housing 2 the associated notches 27 are secured to the key 1.

The notches 27 are located in particular on the side faces 21 of the key 1, and the resiliently retractable lugs 13 are carried by each of the lateral sides of the cavity 16, where they are configured, for example, to be actuated from outside the housing 2 like a push-button and to enter the cavity 16 to engage in an associated notch 27 when said key 1 is in the inserted position in the cavity 16 of the housing 2 and when the lugs 13 are in the locking position of the key 1. Each retractable lug 13 preferably features a spring-loaded ball, the ball only partly protruding into the cavity 16 in the locked position (see FIG. 5). In this way, the ball creates a locking constraint which can be unlocked by manual axial action on the key, greater than the force required to hold the key in the cavity 16. In this case, no external actuation is required, but it may be useful to have a removable, outwardly projecting part to enable manual adjustment of the retractable lug 13. For example, the spring of the lug 13 can be supported on one side by the ball and on the other side by a threaded, generally cylindrical support which engages in an associated thread of the housing 2. Screwing the support into the housing 2 enables manual adjustment of the retractable lug 13.

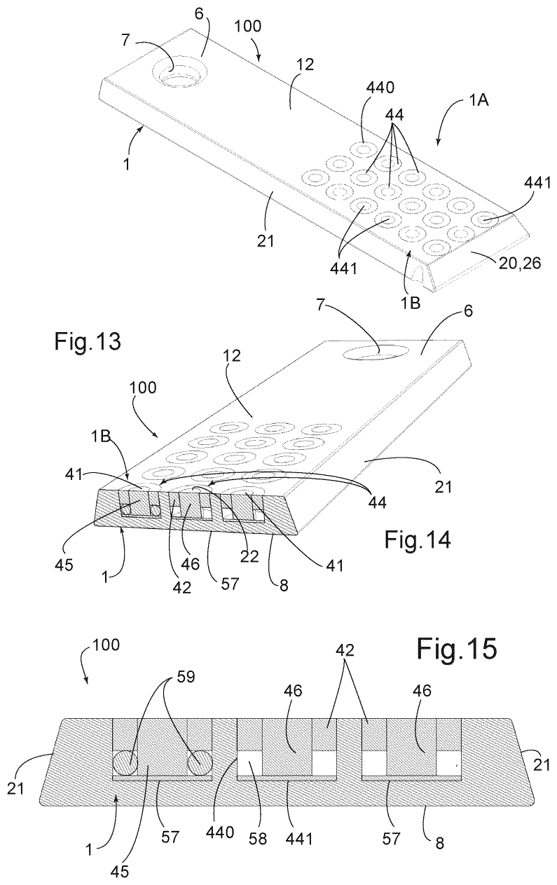

As can be seen in detail in FIG. 2 and FIG. 4, the encrypted portion 1A of the key 1 designed to cooperate in the cavity 16 of the housing 2 has chamfered edges 26, in particular on its side faces 21 and its front face 20. The encrypted portion 1A of the key 1 has a trapezoidal section with sloping sides 21 delimited between a large base carried by a first face 8 or upper surface of the key 1 and a small base carried by a second face 12 or lower surface of the key 1 forming the outer surface of the encryption section 1B designed to face the printed circuit board 4 and ensure contact with each of the electrical contacts 17 when said key 1 is in the position inserted in the cavity 16 of the housing 2. An alternative configuration wherein it is the small base that is carried by a first face 8 or upper surface of the key 1 and it is the large base that is carried by a second face 12 or lower surface of the key 1 is entirely conceivable (see for example FIGS. 13, 14 and 15).

Generally speaking, the cavity 16 of the housing 2 has a complementary shape to that of the encrypted portion 1A of the key 1, so that said encrypted portion 1A of the key 1 slides in the cavity 16 thus created and is constrained in its translation and positioning. This cavity can be defined, for example, by a chamfer, a slide or any other machining technique preferred by the person skilled in the art. This feature makes it possible to limit mechanical stresses on the printed circuit board 4 forming a wall that partly delimits the cavity 16 of the housing 2, and in particular forms the cover 3B, in order to ensure correct positioning of the key 1 relative to the electrical contacts 17 when said key 1 is in the inserted position in the cavity 16 of the housing 2. This feature also facilitates the use of the multi-contact system 100 to guarantee the user the correct positioning of the key 1 as soon as it is inserted, like a keying feature.

As shown in particular in FIG. 3, the electrical contacts 17 are connected to a computing unit 15 configured to communicate with an effector 40. The computing unit 15 comprises at least one microprocessor and/or microcontroller. Preferably, the computing unit 15 is part of an electronic board. In each of the embodiments shown, the computing unit 15 comprises a microcontroller.

According to one embodiment, the electrical contacts can be connected to a microcontroller configured to communicate with the effector 40. In this case, preferably:
the microcontroller 15 is configured to communicate with the effector 40 by sending it information such as a predetermined encryption-for example a key comprising a few hundred or even thousands of bits, if a predetermined combination of electrical contacts 17 are connected to a predetermined electrical pole; and/or
the microcontroller 15 is configured to detect electrical contacts in an electrified state, and preferably, when an erroneous combination, different from the predetermined combination of electrical contacts, is detected, the microcontroller 15 triggers a refractory period preventing any further testing of the key 1 for a predefined time.

FIG. 6 shows a schematic diagram of the operating principle of an electrical contact 17, according to one embodiment.

The electrical contacts 17 are provided with resilient means 31 to enable good contact with the associated face of the key 1, that is, with the encryption section 1B of the encrypted portion 1A of the key 1.

The electrical contacts 17 each comprise an assembly of two sliding cylinders 29, 34 constrained together by an internal spring 31. In particular, such resilient means 31 enable said electrical contacts 17 to be resiliently constrained into contact with and into abutment against the encryption section 1B of the encrypted portion 1A of the key 1, in the inserted position of the key 1 in the cavity 16 of the housing 2.

The electrical contact 17 shown in FIG. 6 corresponds to a Pogo ™ pin 39. Thus, in one embodiment, each electrical contact 17 forms a connector comprising: a base which is fixed relative to the housing 2 and has a fixed tubular portion 34 delimiting a first cylinder and receiving a second cylinder which can move in translation relative to the first cylinder, forming a piston 29 of the connector. The piston 29 is spring-loaded by an internal spring 31. The internal spring 31 is arranged between a wall 32 forming a base of the connector 39 and a distal end 33 of the piston 29 opposite the wall 32. The piston 29 can therefore slide in a direction of translation 38 of the piston 29, in this case along an axis orthogonal to the horizontal reference plane.

The height of the base is approximately equal to the thickness of the printed circuit board 4. In this way, a collar of the fixed base of each connector can make contact with an outer wall of the housing 2 to ensure attachment thereof to the housing 2, the fixed tubular portion 34 being integrally housed in a hole of the printed circuit board 4 here forming the cover 3B of the housing 2. The bottom of the connector 39 base is accessible from outside the housing 2 to allow contact 30 of the connector 39.

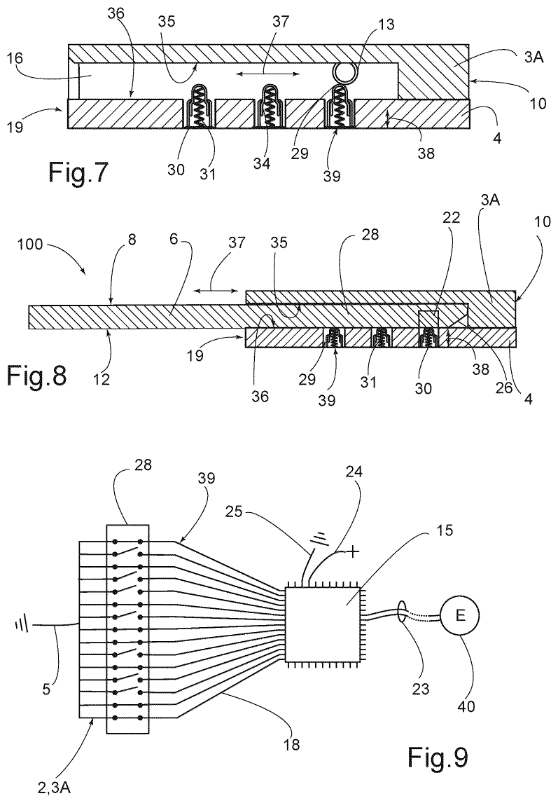

FIG. 7 shows a vertical cross-section of the housing 2 passing through several electrical contacts 17, in a position with no key 1, that is, without the key 1 inserted in the associated cavity 16 of the housing 2.

FIG. 8 in turn shows a figure similar to FIG. 7, with the key 1 inserted in the housing 2.

The connectors 39 are movable between:
a position retracted into the thickness of the printed circuit board 4 when the piston 29 is constrained by the encrypted portion 1A of the key 1, in particular by the encryption section 1B of the encrypted portion 1A of the key 1, when the key 1 is inserted into the cavity 16 of the housing 2; and
a deployed position of the piston 29 in the cavity 16 of the housing 2 wherein the internal spring 31 is released, when the cavity 16 of the housing 2 is empty, that is, no key 1 is inserted.

In general, such connectors 39 are particularly suitable for temporary connections and are generally designed to withstand several hundred thousand cycles of insertion and release of the piston 29.

The electrical contacts 17 then come to rest against the metal encryption section 1B of the encrypted portion 1A of the key 1 when it is in its cavity directly in contact with metal or an insulating zone 22. When the contact 17 touches the metal of the encryption section 1B of the encrypted portion 1A of the key 1, it forms a closed switch, whereas it forms an open switch when it touches an electrically insulating zone 22.

FIG. 9 shows a schematic depiction of the operating principle of the multi-contact system 100 as according to the embodiment of FIG. 1.

The computing unit 15 is configured to communicate with the effector 40 by sending it information such as a predetermined encryption key, for example a 128-bit or 256-bit key, if a predetermined combination of electrical contacts 17 connected to a predetermined electrical pole is ensured when the key 1 is inserted into the cavity 16 of the housing 2.

The grounding plug 5 of the housing 2 is connected to ground (the negative pole of the vehicle battery) by a wire attached by welding, screwing or any other connector known to the person skilled in the art.

In this example, the grounding plug 5, intended for connection to a pole of an electrical circuit and more likely to ground in the case of direct current or neutral in the case of alternating current, is attached here to the housing 2 by means of a fastening screw 14, as shown in FIG. 1 In this embodiment, an electrically conductive wire 18 connects each connector 39 to an identified terminal of a computing unit 15 in such a way that the computing unit 15 recognizes each wire 18. More precisely, a conductive wire 18 is attached to each connector 39 by means of a connector or solder or in any other way preferred by the person skilled in the art, and is connected to an identified terminal of the computing unit 15, so that the computing unit 15 recognizes the signal emitted by the housing 2, that is, the combination of wires 18 wherein an electrical current flows, corresponding to the electrical contacts forming open switches. The set of electrical contacts 17 thus form a combination of open and closed switches carried by a body 28 of the multi-contact system 100 unique to a given housing 2—key 1 combination to enable transmission of the correct information.

The person skilled in the art will probably connect the wires 18 in a bundle running to the microcontroller 15. As an alternative, the person skilled in the art could choose to attach the computing unit 15 to the underside of the housing 2, so that the connectors 39 are directly connected thereto.

The computing unit 15 is itself supplied with electricity via a ground wire 25 and a wire 24 connected to the vehicle's positive (+) pole (or phase in the case of an AC system). The person skilled in the art will choose the best way to ensure that the response of the computing unit 15 to any signal emanating from the housing 2 is time-delayed, in order to make any attempt to hack the system 100 more difficult and, above all, much more time-consuming. This means that any key 1 test will have to wait a certain amount of time for its result.

The computing unit 15 receives the correct information from the housing 2 via the electrical contacts 17, and after any delay, in turn transmits the correct information to the effector 40 via network 23, such as a wired control network, typically of the CAN type, an electrical harness (or by radio or any other method chosen by the person skilled in the art). The effector 40 is chosen by the person skilled in the art and may, for example and without limitation, be the vehicle's motherboard, the vehicle's computer, the ignition system, the fuel pump, the starter, the steering hydraulic circuit, the servomotor of a lock, or any other component essential to the operation of the vehicle or the system to be protected, etc.

According to one embodiment, the computing unit 15 is configured to detect electrical contacts in an electrified state, and preferably, when an erroneous combination, different from the predetermined combination of electrical contacts 17, is detected, the computing unit 15 triggers a refractory period preventing any further testing of the key 1 for a predefined time. The brute-force attack on the system, which consists in trying out all possible combinations, is therefore very time-consuming.

The device according to the invention is particularly intended for use as a contact device for vehicles. In each of the embodiments shown, the multi-contact system 100 is intended for a vehicle ignition switch. The multi-contact system 100 is designed to recognize the key 1 when a predetermined combination of electrical contacts 17 are connected to a predetermined electrical pole, this predetermined combination of electrical contacts 17 being representative of the insertion of the vehicle key 1 into the housing 2.

In each of the embodiments shown, the ignition switch and the effector 40 together form an ignition control member which is configured to control starting of the vehicle.

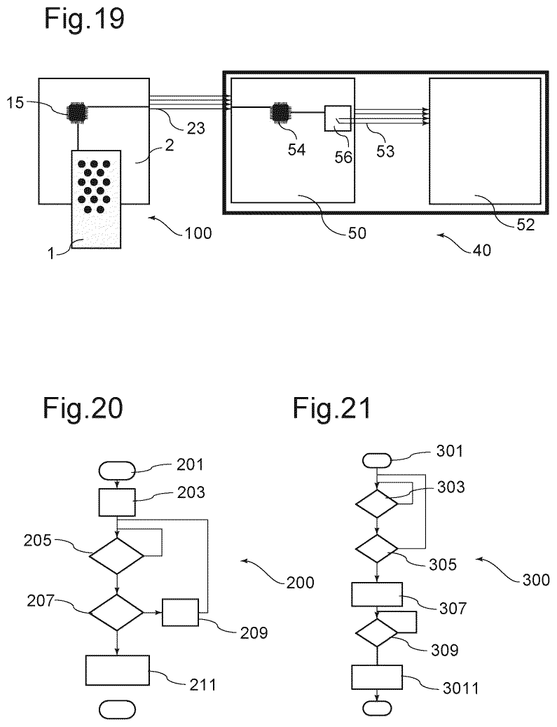

The ignition control member shown in FIG. 19 differs from that shown in FIG. 9 mainly in that a control unit 50 is located between the multi-contact system 100 and a main module 52 of the effector 40. The control unit 50 and the main module 52 shown in FIG. 19 are similar to the effector 40 of the control unit according to the embodiment of FIG. 9.

The multi-contact system 100 shown in FIG. 19 is virtually identical to that shown in FIG. 9. In particular, the multi-contact system 100 recognizes the key 1 when a predetermined combination of electrical contacts 17 are connected to a predetermined electrical pole, this predetermined combination of electrical contacts 17 being representative of the insertion of the vehicle key 1 into the housing 2.

The control unit 50 preferably comprises an electronic control board. The control unit 50 comprises a microprocessor 54 and/or a microcontroller. More generally, the control unit 50 includes a computing unit. The control unit 50 also includes a switch 56, also known as a relay. The control unit 50 is connected to the multi-contact system 100 via the network 23, which is typically a CAN-type wired control network. The start authorization or start prohibition information received by the control unit 50 from the multi-contact system 100 is preferably encrypted. The control unit 50 is configured to command the main module 52 to start the vehicle when the key 1 is inserted into the cavity 16 of the housing 2 and the key 1 is recognized by the multi-contact system 100.

The microprocessor 54 and/or microcontroller of the control unit 50 is electrically connected to the switch 56. In the embodiment shown, the electronic board of the control unit 50 preferably comprises a microprocessor 54. The microprocessor 54 is configured, for example, to communicate with the microcontroller 15 of the housing 2 to receive start information, such as a start authorization or a start prohibition. The switch 56 is electrically connected to the main module 52. The switch 56 is configured to switch between a start position, wherein the effector 40 allows the vehicle to be started, and a stop or no-start position, wherein the effector 40 prevents the vehicle from being started. The switch 56 is connected to the microprocessor 54, and the switch 56 transmits a start or stop command to the main module 56 from the microprocessor 54.

Similarly to the embodiment of FIG. 9, the main module 52 includes, for example and without limitation, the vehicle motherboard, the vehicle ECU, the ignition system, the fuel pump, the starter, the steering hydraulics and the lock actuator. The main module 52 is electrically connected to the control unit 50 in such a way that it is impossible to activate the main module 52 to enable vehicle starting without a start command from the control unit 50. For example, the power supply for the main module 52 is integrated into the control unit 50. As a further example, the main module 52 is configured to be damaged if it is called upon to enable the vehicle to be started in the absence of a start command from the control unit 50.

FIG. 20 shows an operating method 200 for the computing unit 15 of the multi-contact system 100 shown in FIG. 19. In step 201, the computing unit 15 is switched on and operational. The computing unit 15 is switched on, for example, when the vehicle door is opened. A delay 203 is optionally provided between the start of the power supply to the computing unit 15 and the start of key 1 detection. The computing unit 15 then detects the presence or absence of key 1 in the cavity 16 of the housing 2, during a key detection step 205. If a key 1 is detected in the cavity 16 of the housing 2, the multi-contact system 100 checks in a verification step 207 whether the key is recognized. The key 1 is verified by checking that a predetermined combination of electrical contacts 17 are connected to a predetermined electrical pole, this predetermined combination of electrical contacts 17 being representative of the insertion of the vehicle key 1 into the housing 2. If a key 1 is detected and the key 1 is not recognized, it may be detected again whether a key 1 is still present in the cavity 16, and if so, whether the key 1 is recognized in a subsequent verification step 209. If the key 1 is recognized, the computing unit 15 transmits a start command or start authorization command 211 to the control unit 50. FIG. 21 shows an operating method 300 for the control unit 50 of FIG. 19. In step 301, the control unit 50 is switched on and operational. The control unit 50 is switched on, for example, when the vehicle door is opened. A delay 303 may optionally be provided between the start of the power supply to the control unit 50 and the start of detection of a command from the multi-contact system 100. The control unit 50 then detects a possible start/start authorization command from the multi-contact system 100, in a command detection step 305 from the multi-contact system 100. The control unit 50 detects a possible no-start command from the multi-contact system 100, in the command detection step 305 from the multi-contact system 100. When a start/start authorization command has been detected, the switch 56 is urged toward the start position in a switching step 307. When the switch 56 is in the start position, the main module 52 of the effector checks whether the vehicle's engine is switched off in an engine check step 309. If the engine was switched off, it is started. For example, the switch 56 is automatically urged toward the no-start position in a no-start step 311, the no-start position being in particular a safety position of the switch 56, to prevent theft of the vehicle.

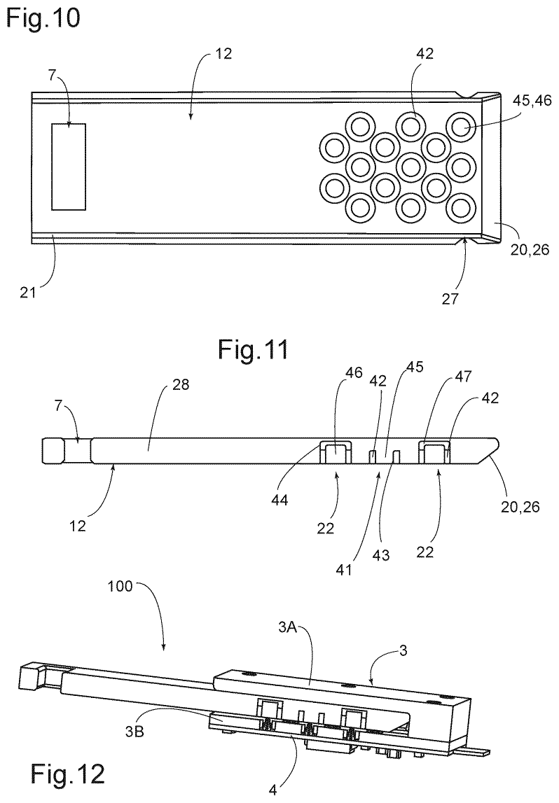

FIGS. 10, 11 and 12 show a multi-contact system 100 according to another embodiment, wherein the contact zones of the encryption section 1B of the encrypted portion 1A of the key 1, each intended to be in contact with one of the electrical contacts 17 in an inserted position of the key 1 in the cavity 16 of the housing 2, are visually identical.

In particular in this embodiment, all contact zones, namely the conductive 41 and insulating 22 contact zones, comprise a metal core 45, 46 surrounded by a ring 42 of electrically insulating material(s). In addition:
in the conductive contact zones 41, each of the metal cores 45 is electrically connected to the electrically conductive material of the encryption section 1B of the encrypted portion 1A of the key 1.
In the insulating contact zones 22, each of the metal cores 46 is electrically insulated from the electrically conductive material of the encryption section 1B of the encrypted portion 1A of the key 1 by means of an insulating envelope consisting at least of the ring 42 and a sleeve 47 of electrically insulating material(s).

According to one embodiment, in the conductive zones 41, the metal cores 45 are connected to the metal body of the key, for example by grooving a space forming a ring-shaped groove 43 around these cores 45, which are an integral part of the body of the key 1; the insulating rings 42 are then filled with an insulating material identical to that used in the insulating zones 22. Once housed in the associated groove 43, each insulating ring 42 is positioned flush with the useful outer surface 12 of the encryption section 1B of the encrypted portion 1A of the key 1.

According to one embodiment, in the insulating zones 22, blind wells 44 are machined on the useful outer surface 12 of the encryption section 1B of the encrypted portion 1A of the key 1, these shafts 44 each having a diameter identical to that of the ring-shaped grooves 43 previously described. At the bottom of these wells 44 are insulating sleeves 47 to isolate the metal cores 46 from the metal body of the key.

In particular, these sleeves 47 each have: an external diameter such that they fit into the wells 44, an internal diameter enabling part of the metal cores 46 to be inserted therein, and a height such that there remains sufficient space to place the same insulating material therein to form the same insulating ring 42 as that of the conductive zones.

The metal cores 46 of the insulating zones 22 have the same diameter as the metal cores 45 of the conductive zones 41, and are of such a height that they are flush with the lower surface of the key 1 when they are embedded inside the sleeves 47 and abut the insulating surface of the associated sleeve 47. The assembly is held together by gluing, forcing or any other means chosen by person skilled in the art. The same insulating material is then placed between the metal cores 46 and the inner walls of the wells 44 so that an insulating ring 42 flush with the useful outer surface 12 of the encryption section 1B of the encrypted portion 1A of the key 1 is formed.

It should be noted that the embodiment shown in FIG. 12 differs substantially from that shown in FIG. 11 in that the cover 3B and the printed circuit board 4 are two separate parts, even though they are secured to one another.

During use, the key 1 thus pushes a combination of conductive contact zones 41 against electrical contacts 17 formed by Pogo™ pins 39 on a printed circuit board 4 attached beneath the housing 3. These electrical contacts 17 are connected to electrical ground via the key 1. This unique combination of electrified contacts sends the correct signal (password or electronic key) contained in a computing unit 15 to the electronic board 4, enabling one or more actions of the manufacturer's choice, e.g. starting a vehicle, activating a CAN bus, ignition, releasing the handbrake, etc. If the wrong combination is activated, the computing unit 15 can be rendered inactive for a predetermined period, e.g. 30 seconds.

In a first embodiment, a multi-contact system 100 has been described wherein the electrically insulating zones 22 comprise, in particular consist of, recesses formed in the encryption section 1B of the encrypted portion 1A of the key 1, or more generally in the body of the key 1, and filled with an electrically insulating material. In this case, the conductive contact zones 41 are formed by the electrically conductive metal body of the key 1. This embodiment is particularly apparent, for example, in FIGS. 4, 5 and 8.

In a second embodiment described with reference to FIGS. 10, 11 and 12, the multi-contact system 100 is such that the insulating contact zones 22 each comprise a metal core 45 embedded in an electrically insulating material, that is, surrounded by the ring 42 and the sleeve 47 made of electrically insulating material(s), the conductive contact zones 41 being made by connecting each of the metal cores 46 electrically to the electrically conductive material of the encryption section 1B of the encrypted portion 1A of the key 1, owing to the absence of the sleeve 47 in the conductive contact zones 41.

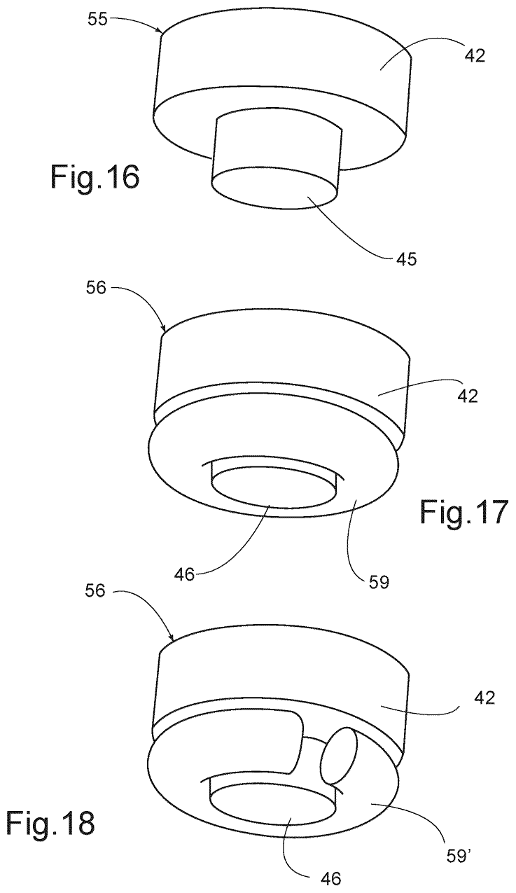

To further facilitate the manufacture of the multi-contact system 100, a further embodiment has been developed wherein the machining of the key does not depend on the key code itself. FIGS. 13, 14, 15, 16 and 17 show a multi-contact system 100 according to another such embodiment. This embodiment differs essentially from those described above in the configuration of the contact zones of the encryption section 1B of the encrypted portion 1A of the key 1.

As shown in FIG. 1, recesses forming wells 44, preferably cylindrical in shape, are machined, for example bored, into the body of the key 1 following the topography of the electrical contacts 17 and associated conductive 41 and insulating 22 contact zones provided. These recesses, forming wells 44, are designed to receive insulating studs 56 or conductive studs 55, depending on the code of the key 1. This key 1 can be easily manufactured by molding techniques with the wells 44 concomitantly formed during this molding step owing to the mold configured for such a molding step.

These blind wells 44 are open on the useful outer surface 12 of the encryption section 1B of the encrypted portion 1A of the key 1. Each well 44 has a cylindrical shape delimited by a cylindrical side wall 440 and a bottom 441 opposite the opening of the associated well 44, which has the shape of a disk.

At the bottom of each well 44 is an insulating partition 57 made from an insulating material. In this case, this partition 57 is an insert in the form of a thin insulating disk, but it can also take the form of a suitable coating, such as an insulating paint.

In another embodiment which is not shown, it could be preferable to place an insulating partition 57 at the bottom 441 of the wells 44 located on insulating contact zones 22 and to place a partition made of a conductive material at the bottom 441 of the wells 44 intended to form conductive contact zones 41, even if this approach adds a production phase generating an increase in costs and process time, is a source of error and prevents the production of identical key bodies with all the bottoms 441 of the wells 44 covered by the same insulating partition 57.

Each of the wells 44 is configured to receive a conductive stud 55 or an insulating stud 56 respectively supporting a conductive contact zone 41 or an insulating contact zone 22.

In this embodiment, all the contact zones, conductive 41 and insulating 22, comprise a metal core 45, 46 surrounded by a ring 42 of electrically insulating material(s).

Each stud 55, 56 comprises the metal core 45, 46, which may be cylindrical, for example, and surrounded by an insulating ring 42 in the form of a sleeve made of insulating material.

Each metal core 45, 46 has an external diameter strictly smaller than an internal diameter of the associated well 44. In this way, the corresponding metal core 45, 46 can be inserted into the associated well 44 leaving a gap between it and the side wall 440 of the associated well 44 so that insulating material in the form of a sleeve can be inserted, and interposed, between it and the side wall 440 of the associated well 44. This allows the corresponding stud 55, 56 to be held securely.

Each metal core 45, 46 has a height complementary to an associated partition height 57, so that the sum of the height or thickness of the partition 57 and the metal core 45, 46 is equal to a height or depth of the associated well 44. In general, the height of each metal core 45, 46 is chosen so that:
an upper face of said metal core 45, 46 is flush with the surface of the useful outer surface 12 of the encryption section 1B of the encrypted portion 1A of the key 1; and that
a lower face of said metal core 45, 46, opposite the upper face, makes contact and bears against the associated insulating partition 57 placed at the bottom 441 of the associated well 44.

The insulating ring 42 forms a sleeve of electrically insulating material(s). The insulating ring 42 can be a part attached to the metal core 45, 46, for example by being set around it, or preferably molded around the metal core 45, 46, or even introduced into the well 44 by liquid-phase or solid-phase force casting. If the insulating sleeve 42 is made of a solid material, it is configured so that:
an upper face of said insulating ring 42 is flush with the surface of the useful outer surface 12 of the encryption section 1B of the encrypted portion 1A of the key 1 in an assembled position; and that
a height of said insulating ring 42 is strictly less than a height of the associated well 44, so that in the assembled position, an annular space 58 is vertically delimited by said insulating ring 42 and the bottom 441 of the well 44, and preferably between the insulating ring 42 and the partition 57; and
a radial width of the insulating ring 42 configured to fit snugly and concentrically between the metal core 45, 46 and the side wall 440 of the associated well 44: in this way, the insulating ring 42 can be pressed into the well 44 to be securely attached and to hold or assist in holding the metal core 45, 46. The annular space 58 preferably has a volume configured to act as a compression chamber so that the air trapped at the bottom of the well 44 does not force the stud 314 upwards.

In the case of a conductive stud 55 intended as a support for the conductive contact zone 41, this comprises the metal core 45 which may, for example, have the shape of a cylinder surrounded:
on its upper part by an insulating ring 42 forming a sleeve of insulating material; and
on its lower part, by an electrically conductive element 59, 59′, at least partly annular, located vertically under the insulating ring 42.

FIG. 17 shows the embodiment in which the element 59 is completely annular, completely surrounding the lower part of the metal core 45. In this example, the element 59 is shaped like a torus.

FIG. 18 shows a variant of FIG. 17 wherein the element 59′ is partially annular, surrounding the lower part of the metal core 45 only over a predetermined angular sector, this angular sector preferably being greater than or equal to 270°, more preferably greater than or equal to 315°. It is indeed advantageous that the partially annular element 59′ surrounds the metal core 45 sufficiently to enable it to be easily fitted around said metal core 45 and thus be held by clamping said metal core 45. This facilitates assembly operations of the conductive studs 55 in the body of the key 1 during the assembly method. It is in fact easy to handle the corresponding stud without the component parts of the studs coming apart.

The dimensions and shape of each metal core 45 are configured so that it can be inserted into the corresponding wells 44 leaving an annular space between it and the side wall 440 of the wells 44 so that an insulating material in the form of an insulating ring 42 and an at least partially annular element 59, 59′ can be inserted, and interposed, between it and the side wall 440 of the well 44

The height of each metal core 45 is configured so that:
an outer face of the cylinder is flush with the useful outer surface 12 of the encryption section 1B of the encrypted portion 1A of the key 1, and that
another face, or inner face, vertically opposite the outer face, makes contact and presses against the insulating or conductive material placed at the bottom 441 of the associated well 44 in the form of a partition 57.

The metal ring 59, 59′ is designed to conduct electricity between the body of the key and the metal core 45, whether the metal core 45 is placed on the conductive or insulating material of the partition 57. In the assembled position, this ring 59, 59′ is housed in the annular space 58. Thus, in the conductive contact zones 41, each of the metal cores 45 is electrically connected to the electrically conductive material of the encryption section 1B of the encrypted portion 1A of the key 1.

The metal ring 59, 59′ is made of an electrically conductive material, in particular metal. It can take a complete 59 or incomplete 59′, solid or hollow, form or take the form of a helical spring or any other form preferred by the person skilled in the art. An incomplete ring 59′ or a spring offer configurations that allow easier adaptation to the desired compression function between the metal core 45 and the side wall 440 of the associated well 44. It can be placed at the bottom 440 of the well 44 before the metal core 45 is inserted into the associated well 44, or placed around the metal core 45 under the insulating ring 42, the whole assembly then being pressed into the well 44. The diameter of the metal ring 59, 59′ is such that it is radially compressed between the metal core 45 and the side wall 440 of the associated well 44 to ensure good electrical conduction between the metal core 45 and the key 1.

An insulating stud 56 has no metal ring 59, 59′. The annular space 58 then acts as an insulating separation. In the insulating contact zones 22, each of the metal cores 46 is thus electrically insulated from the electrically conductive material of the encryption section 1B of the encrypted portion 1A of the key 1 by means of

In the case where:
the insulating studs 56 are prepared entirely in advance and consist of a metal core 46 and an insulating ring 42; and wherein
the conductive studs 55 are prepared entirely in advance and comprise a metal core 45, an insulating ring 42 and a conductive element 59, 59′; simply insert each pre-assembled stud provided by the code the key 1 into the corresponding well 44 to finalize the key 1. The use of cold to reduce the size of the studs 55, 56 before they are inserted into the wells 44 can be of great benefit here, since the subsequent expansion will keep each stud 55, 56 in its well 44 and without the use of glue or solder.

Owing to such a design, the contact zones of the encryption section 1B of the encrypted portion 1A of the key 1, each intended to be in contact with one of the electrical contacts 17 in a position in which the key 1 is inserted into the cavity 16 of the housing 2, are visually identical, improving the security of the associated system 100.

Preferably, each pair of a metal core 45, 46 and an insulating ring 42 is identical for all contact zones, that is, for all wells 44. In addition, the wells 44 are preferably all identical. This further optimizes manufacturing costs without compromising key security. This further ensures that contact zones are visually identical.

Owing to the multi-contact system 100 according to the invention, the key has a simple structure and operation, the key furthermore being free of any electronic device such as an electric circuit or a microprocessor as in the solutions of the prior art.

Moreover, its operation is purely digital, further simplifying its operation instead of the analog solutions of the prior art, without compromising security and guaranteeing its level of reliability and tamper-proofing.

Of course, the invention is described in the foregoing by way of example. It is understood that a person skilled in the art is able to produce different variant embodiments of the invention without departing from the scope of the invention.

For example, it can be envisaged that the electrical contact consists solely of a conductive metal wall of the key and that each contact zone is equipped with a contactor such as a Pogo™ pin.

For example, the housing may also comprise an encryption section with an encrypted portion, for example to make it more difficult to illegally reproduce the housing of the multi-contact system.

It is emphasized that all of the features, as they are taught to a person skilled in the art from the present disclosure, drawings and attached claims, even though specifically they have been described in relation to other determined features, both individually and in any combinations, may be combined with other features or feature groups disclosed herein, provided that this has not been expressly excluded and that no technical circumstances make such combinations impossible or nonsensical.

1. A multi-contact system comprising a housing delimiting a cavity configured to receive at least an encrypted portion of a key, the encrypted portion of the key having an encryption section formed at least in part by an electrically conductive material, the housing comprising a plurality of electrical contacts on an inner surface of the cavity intended to make contact with the encryption section of the encrypted portion of the key when said key is in an inserted position in the cavity of the housing, said electrical contacts being connected to a computing unit configured to communicate with an effector, the multi-contact system being characterized in that the encryption section of the encrypted portion of the key comprises electrically insulating zones, the multi-contact system being configured to form, when the key is in the inserted position in the cavity of the housing:
an open switch for each of the electrical contacts located opposite an insulating contact zone of the encryption section of the encrypted portion of the key formed by one of the insulating zones; and
a closed switch for each of the electrical contacts which is in contact with a conductive contact zone of the encryption section of the encrypted portion of the key outside these insulating zones, the conductive contact zone being electrically conductive.

2. The multi-contact system according to claim 1, wherein the housing comprises a housing body and a cover, the cavity of the housing being delimited at least in part by the body of the housing and the cover, the electrical contacts preferably being secured to the cover.

3. The multi-contact system according to claim 1, characterized in that it comprises a printed circuit board secured to the housing, the printed circuit board preferably being secured to a cover, the printed circuit board preferably also constituting the cover.

4. The multi-contact system according to claim 1, wherein the contact zones of the encryption section of the encrypted portion of the key, each intended to be in contact with one of the electrical contacts in a position in which the key is inserted into the cavity of the housing, are visually identical.

5. The multi-contact system according to claim 1, wherein all or some of the contact zones comprise a metal core surrounded by a ring of electrically insulating material(s).

6. The multi-contact system according to claim 5, wherein, in the conductive contact zones, each of the metal cores is electrically connected to the electrically conductive material of the encryption section of the encrypted portion the key.

7. The multi-contact system according to claim 5, wherein, in the insulating contact zones each of the metal cores is electrically insulated from the electrically conductive material of the encryption section of the encrypted portion of the key by means of an insulating envelope consisting at least of the ring and a complementary element such as a sleeve or partition made of electrically insulating material(s).

8. The multi-contact system according to claim 1, wherein the key has recesses forming wells located at each contact zone for receiving studs, each well of a conductive contact zone being configured to receive a conductive stud and each well of an insulating contact zone being configured to receive an insulating stud, each of the studs preferably comprising a metal core (45, 46) surrounded by a ring (42) of electrically insulating material(s).

9. The multi-contact system according to claim 8, wherein each conductive stud is surrounded, at least in part on a lower part, by an electrically conductive element located vertically beneath the insulating ring, so as to conduct electricity between the metal core and a side wall of an associated well in the inserted position of the corresponding conductive stud.

10. The multi-contact system according to any one of claims 1, wherein the electrically insulating zones are formed at least in part by, preferably consist of, an insulating coating deposited locally on the surface of the encryption section of the encrypted portion of the key.

11. The multi-contact system according to claim 1, wherein the key has recesses located at each insulating zone and filled at least in part with an electrically insulating material, this material having an outer surface flush with an outer surface of the encryption section of the encrypted portion of the key in order to limit wear on the electrical contacts against which the key rubs when it is inserted into its cavity.

12. The multi-contact system according to claim 1, further comprising at least one resiliently retractable lug configured to penetrate the cavity and insert into a notch in the encrypted portion of the key when said key is in the inserted position in the cavity of the housing so as to maintain the key in its inserted position and inform a user of a correct inserted position of said key.

13. The multi-contact system according to claim 1, wherein the cavity of the housing has a complementary shape to that of the encrypted portion of the key, so that said encrypted portion of the key (1) can slide in the cavity (16) while being guided and constrained in its translation and positioning.

14. The multi-contact system according to claim 2, characterized in that the body of the housing is made of metallic material(s) and connected to an electrical terminal of an electrical dipole.

15. The multi-contact system according to claim 2, wherein the body of the housing is made of electrically insulating material(s), for example plastic material(s), the body of the housing comprising a plug for connecting an electrical terminal of an electrical dipole to the key when said key is in its inserted position in the housing.

16. The multi-contact system according to claim 1, wherein the electrical contacts comprise resilient means configured to resiliently constrain said electrical contacts in contact and in abutment against the encryption section of the encrypted portion of the key, in the inserted position of the key in the cavity of the housing.

17. The multi-contact system according to claim 1, wherein the encrypted portion of the key intended to cooperate in the cavity of the housing has side faces each chamfered so as to have a trapezoidal cross-section, a distal end of the encrypted portion of the key preferably also having a chamfered front face.

18. The multi-contact system according to claim 1, wherein the electrical contacts each comprise an assembly of two sliding cylinders constrained against one another by an internal spring.

19. The multi-contact system according to claim 1, wherein the computing unit is configured to communicate with the effector by sending it information such as a predetermined encryption key, for example a key comprising a few hundred or even thousands of bits, if a predetermined combination of electrical contacts are connected to a predetermined electrical pole.

20. The multi-contact system according to claim 1, wherein the computing unit is configured to detect electrical contacts in an electrified state, and preferably, when an erroneous combination, different from a predetermined combination of electrical contacts, is detected, the computing unit triggers a refractory period preventing any further testing of the key for a predefined time.

21. An actuating mechanism for an apparatus, comprising a multi-contact system according to claim 1, the actuating mechanism being configured to command the effector to actuate the apparatus when the key is inserted into the cavity of the housing and the key is recognized by the multi-contact system, in particular when a predetermined combination of electrical contacts are connected to a predetermined electrical pole, the predetermined combination being representative of the insertion of the key of the apparatus into the cavity of the housing.

22. The actuating mechanism according to claim 21, wherein the actuating mechanism forms an ignition switch for an apparatus such as a motorized road vehicle, with actuation of the apparatus corresponding to starting of the vehicle.

23. An actuation control member comprising an effector and a multi-contact system according to claim 1, the actuation control member comprising a control unit including a microprocessor and/or a microcontroller, the control unit being configured to allow actuation of an apparatus when the key is inserted in the cavity of the housing and the key is recognized by the multi-contact system, the control unit being connected to a main module of the effector by a switch which is configured to switch between an actuation position wherein the effector allows actuation of the apparatus and a stop position wherein the effector prevents actuation of the apparatus.

24. The control member according to claim 23, wherein the control member forms an ignition member for an apparatus such as a motorized road vehicle, with actuation of the apparatus corresponding to starting of the vehicle.
